(19) United States
(12) Patent Application Publication
(10) Pub. No.: US 2026/0316208 A1
(43) Pub. Date: Oct. 15, 2026

(54) MACHINE TOOL CONTROL DEVICE

(71) Applicant: FANUC CORPORATION, Minamitsuru-gun, Yamanashi (JP)

(72) Inventor: Masashi YASUDA, Yamanashi (JP)

(73) Assignee: FANUC CORPORATION, Minamitsuru-gun, Yamanashi (JP)

(21) Appl. No.: 19/106,574

(22) PCT Filed: Sep. 22, 2022
(86) PCT No.: PCT/JP2022/035419

§ 371 Date: Feb. 25, 2025

(51) Int. Cl. B23Q 15/013

(52) U.S. Cl. CPC B23Q 15/013

(57) ABSTRACT

Provided is a feature with which it is possible to precisely achieve a desired surface roughness even if a cutting tool is replaced after the start of processing or if the shape of a blade edge of the cutting tool has changed, to improve the readability of a processing program, and to reduce the time and effort required in creating the processing program. Specifically, provided is a control device 1 for a machine tool that processes a workpiece W while moving the workpiece W relative to a cutting tool T, the machine tool control device 1 comprising: a surface roughness acquisition unit 11 that acquires, from a processing program, a target surface roughness set for a workpiece W being processed; a tool surface roughness information acquisition unit 12 that acquires tool surface roughness information relating to the surface roughness of the cutting tool T; and a feeding amount control unit 14 that, on the basis of the tool surface roughness information, determines feeding amount information relating to a feeding amount per relative rotation of the cutting tool T and the workpiece W such that the surface roughness of the workpiece W reaches the target surface roughness.

### TECHNICAL FIELD

The present invention relates to a machine tool control device.

### BACKGROUND ART

Conventionally, a technique has been known in which a feed amount for a spindle that moves a workpiece to be machined is specified in advance in a machining program or the like, and then, cutting is performed (see, for example, Patent Documents 1 and 2).

### CITATION LIST

### Patent Document

Patent Document 1: Japanese Unexamined Patent Application, Publication No. 2003-323204
Patent Document 2: Japanese Unexamined Patent Application, Publication No. 2018-094690

### DISCLOSURE OF THE INVENTION

### Problems to be Solved by the Invention

Incidentally, surface roughness is one of the indicators related to a machined workpiece. The surface roughness depends on the shape of the cutting edge of a cutting tool and a feed amount. Therefore, it is common to determine a feed amount per unit time for a spindle such that the machined workpiece will have a desired surface roughness.

When the cutting tool is replaced in the middle of the cutting or the shape of the cutting edge of the cutting tool changes due to wear or the like, it is necessary to change the feed amount; but the cutting is continued with the feed amount unchanged. A feed amount that does not correspond to an appropriate condition may prevent achievement of a desired surface roughness.

According to a method of setting in a machining program a feed amount to which a surface roughness is reflected, it is difficult to grasp the surface roughness, which is one of the indicators, from the machining program. Thus, the known art has room for improvement in terms of enhancement of readability.

Such a method of setting in a machining program a feed amount to which a surface roughness is reflected requires an operation of calculating the feed amount that allows the machined workpiece to have a desired surface roughness and an operation of reflecting the calculated feed amount in the machining program. Therefore, time and effort are necessary to perform these operations.

The present disclosure has been achieved in view of the above disadvantages, and an object the present disclosure is to provide a technique in which a desired surface roughness can be accurately achieved even in a case where a cutting tool is replaced or the shape of the cutting edge of the cutting tool changes after the start of machining, the readability of a machining program can be improved, and the time and effort for creating a machining program can be reduced.

### Means for Solving the Problems

The present disclosure relates to a machine tool control device for a machine tool that performs machining while relatively moving a cutting tool and a workpiece, the machine tool control device including: a surface roughness acquisition unit configured to acquire a target surface roughness set for the workpiece to be machined from a machining program; a tool surface roughness information acquisition unit configured to acquire tool surface roughness information regarding a surface roughness of the cutting tool; and a feed amount control unit configured to determine, based on the tool surface roughness information, feed amount information regarding a feed amount per relative rotation of the cutting tool and the workpiece such that a surface roughness of the workpiece becomes equal to the target surface roughness.

### Effects of the Invention

The present disclosure can provide a technique in which a desired surface roughness can be accurately achieved even in a case where a cutting tool is replaced or the shape of the cutting edge of the cutting tool changes after a start of machining, the readability of a machining program can be improved, and the time and effort for creating a machining program can be reduced.

### BRIEF DESCRIPTION OF THE DRAWINGS

FIG. 1 is a functional block diagram of a machine tool control device according to a first embodiment;

FIG. 2 is a schematic diagram illustrating an example of cutting in which a target surface roughness is set;

FIG. 3 illustrates an example of a machining program;

FIG. 4 illustrates an example of a table of tool surface roughness information;

FIG. 5 is a functional block diagram of a machine tool control device according to a second embodiment;

FIG. 6 is a diagram for explaining oscillating cutting;

FIG. 7 is a functional block diagram of a machine tool control device according to a third embodiment;

FIG. 8 is a functional block diagram of a machine tool control device according to a fourth embodiment;

FIG. 9 is a functional block diagram of a machine tool control device according to a fifth embodiment; and

FIG. 10 is a functional block diagram of a machine tool control device according to a sixth embodiment.

### PREFERRED MODE FOR CARRYING OUT THE INVENTION

Embodiments of the present disclosure will be described below in detail with reference to the drawings. In the descriptions of the second and subsequent embodiments, components in common with the first embodiment are denoted by the same reference signs, and description thereof is omitted as appropriate.

### First Embodiment

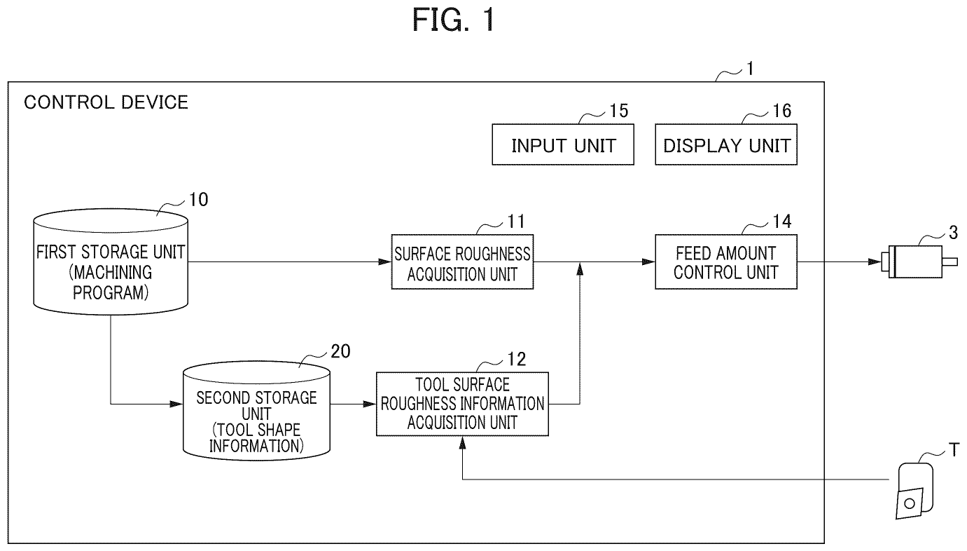

FIG. 1 is a functional block diagram of a machine tool control device 1 according to a first embodiment. The control device 1 according to the first embodiment controls a machine tool that performs machining while relatively moving a cutting tool T and a workpiece. The control device 1 operates at least one spindle that relatively rotates the cutting tool T and the workpiece and at least one feed shaft that moves the cutting tool T relative to the workpiece, thereby causing the tool to cut the workpiece.

For the sake of convenience, FIG. 1 illustrates only the cutting tool T and a motor 3 that drives one feed shaft. For the cutting according to the present embodiment, the workpiece is not limited to any shape. Specifically, the cutting according to the present embodiment is applicable to a case where a plurality of feed axes (a Z-axis and an X-axis) are necessary to machine a workpiece having a tapered portion or an arc-shaped portion on a surface thereof to be machined and a case where a specific single feed axis (a Z-axis) is sufficient to machine a workpiece having a circular columnar shape or a cylindrical shape.

As illustrated in FIG. 1, the machine tool control device 1 according to the first embodiment includes a first storage unit 10, a surface roughness acquisition unit 11, a second storage unit 20, a tool surface roughness information acquisition unit 12, and a feed amount control unit 14. The machine tool control device 1 is constituted by, for example, a computer including memories such as a read only memory (ROM) and a random access memory (RAN), a central processing unit (CPU), and a communication control unit, which are connected to each other via a bus. The functions and operations of these functional units are implemented by cooperation between the CPU and the memories incorporated in the computer and control programs stored in the memories.

The machine tool control device 1 may be constituted by a computer numerical controller (CNC), or may be connected to a host computer (not shown) such as a CNC, a programmable logic controller (PLC), or the like. The host computer inputs, in addition to a machining program, machining conditions such as a rotation speed and the like to the machine tool control device 1.

The first storage unit 10 stores therein the machining program to be executed by the machine tool. The machining program includes machining conditions and the like for machining the workpiece. The machining conditions for the workpiece include a relative rotation speed of the workpiece and the cutting tool T around the central axis of the workpiece, a relative feed rate of the cutting tool T and the workpiece, a position command for the feed shaft, a target surface roughness, and the like.

The target surface roughness is a value of a desired surface roughness set for the workpiece to be machined. The surface roughness includes, for example, at least one of the following: an arithmetic mean roughness, a maximum height that is a maximum value of a distance between a peak and a valley, a maximum peak height that is a maximum value of a height from an average line of the surface, a maximum valley depth that is the absolute value of a minimum value of a height from the average line of the surface, an average height that is an average value of heights of contour curve elements of pairs each composed of adjacent peak and valley, a maximum cross-sectional height that is the sum of a maximum value of a peak height and a maximum value of a valley depth of the contour curve elements, or a load length ratio that is a ratio of a load length of the contour curve elements at a predetermined cutting level (height % or μm) to an evaluation reference length. The foregoing are representative and non-limiting examples of the surface roughness indictors, and another surface roughness indicator may be used.

The surface roughness acquisition unit 11 acquires the target surface roughness, which is a surface roughness to be achieved, from the machining program. In the first embodiment, the surface roughness acquisition unit 11 acquires the target surface roughness, which is set in the machining program, via the first storage unit 10, and outputs the acquired target surface roughness to the feed amount control unit 14.

The second storage unit 20 stores therein tool surface roughness information regarding a surface roughness of the cutting tool T. An example of the tool surface roughness information regarding the surface roughness of the cutting tool T is information specifying the shape of the cutting tool T (tool shape information). The tool shape information includes, for example, information indicating the shape of the cutting edge, such as a nose R (mm) indicating the diameter of the cutting edge of the cutting tool T. The second storage unit 20 acquires the information specifying the shape of the cutting tool T from the machining program and stores the information therein.

The tool surface roughness information regarding the surface roughness of the cutting tool T may be, for example, information (e.g., table data, a relational expression, or the like) indicating a relationship between a feed rate and a surface roughness resulting from machining at the feed rate.

The tool surface roughness information regarding the surface roughness of the cutting tool T may be information itself relating to the surface roughness of the cutting tool T, or may be indirect information such as a tool number specifying tool shape information. In the latter case, a mode may be used in which the second storage unit 20 stores therein tool numbers as the indirect information and a numerical value of a nose R (mm) corresponding to each tool number in a table format, and the cutting tool T in use is identified by identifying the tool number in the machining program or the tool number of the cutting tool T connected.

The second storage unit 20 further stores information indicating tool surface roughness information regarding a current surface roughness of the cutting tool T acquired from the cutting tool T connected to the control device 1. By acquiring the information indicating the tool surface roughness information regarding the surface roughness from the cutting tool T, a change that occurs in the tool surface roughness information regarding the surface roughness of the cutting tool T after machining due to replacement, wear, or the like of the cutting tool T is also reflected in the second storage unit 20. The information indicating the tool surface roughness information regarding the current surface roughness of the cutting tool T acquired from the cutting tool T may be information itself relating to the surface roughness of the cutting tool T, or may be indirect information such as a tool number or the like. For the detection of a change in the tool surface roughness information regarding the surface roughness of the cutting tool T, for example, an external signal indicating that replacement with a new cutting tool T has been carried out may include information specifying the tool surface roughness information regarding the surface roughness of the cutting tool T. The detection of a change in the tool surface roughness information regarding the surface roughness of the cutting tool T may be performed, for example, by way of image processing by an imaging device or by way of measurement of the shape of the cutting edge using a contact type or non-contact type sensor.

The tool surface roughness information acquisition unit 12 acquires the tool surface roughness information regarding the cutting tool T from the second storage unit 20. The tool surface roughness information acquisition unit 12 may operate in a mode in which it acquires the tool surface roughness information stored in the second storage unit 20, or in a mode in which it identifies the tool surface roughness information from among pieces of information that specify cutting tools T and are stored in the second storage unit 20. The tool surface roughness information acquisition unit 12 outputs the acquired tool surface roughness information to the feed amount control unit 14.

The feed amount control unit 14 determines feed amount information regarding a feed amount per relative rotation of the cutting tool T and the workpiece, and controls driving of the motor 3. The feed amount control unit 14 calculates the feed amount information based on the target surface roughness inputted from the surface roughness acquisition unit 11 and the tool surface roughness information inputted from the tool surface roughness information acquisition unit 12.

The feed amount information is information regarding a feed amount per relative rotation of the cutting tool T and the workpiece. The information regarding the feed amount includes, for example, a feed amount F (mm/rev) per rotation of the spindle. The information regarding the feed amount may include a spindle rotation number (rev/min) and a feed amount (mm/min). Therefore, the feed amount control unit 14 may control both the motor of the feed shaft and the motor of the spindle.

An input unit 15 inputs information regarding machining, in response to an operator performing an input operation via an input means (not shown) such as a keyboard or a touch panel. The information regarding machining inputted by the input unit 15 is stored in the first storage unit 10 or the like, or inputted to each unit of the control device 1.

A display unit 16 displays various kinds of information regarding the machine tool, the control device 1, and the machining.

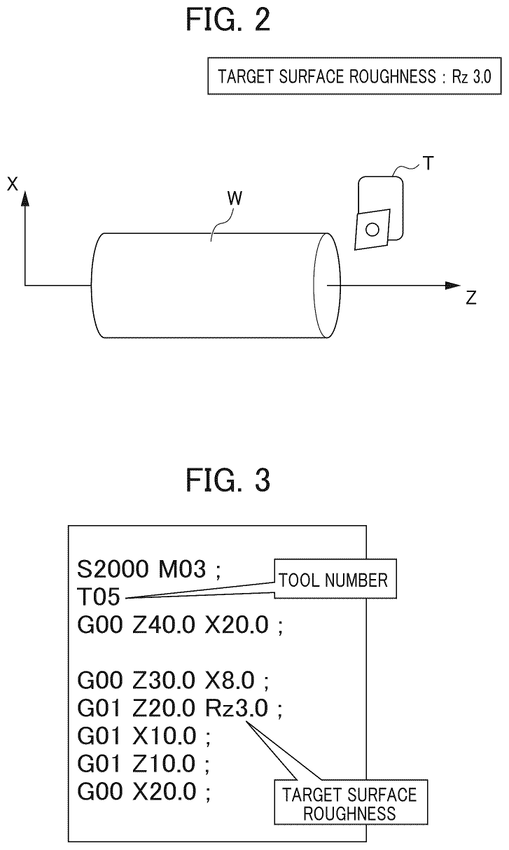

Next, an example of a control processing performed by the control device 1 according to the first embodiment will be described. FIG. 2 is a schematic diagram illustrating an example of cutting in which a target surface roughness is set. In the example illustrated in FIG. 2, “Rz: 3.0” is set in advance as a target roughness in a machining program.

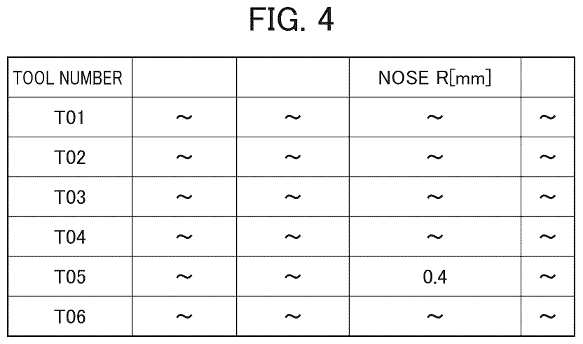

FIG. 3 illustrates an example of the machining program. In the machining program illustrated in FIG. 3, the block “S2000 M03” is a description indicating that the spindle is to be rotated forward. The block “T05” is a description indicating a tool number that serves as information for specifying tool surface roughness information. Blocks starting from “G00” or “G01”, such as “G00 Z40.0 X20.0”, are descriptions indicating behaviors, such as positioning and linear interpolation, and coordinates. Among them, “Rz3.0” in the block “G01 Z20.0 Rz3.0” is a description indicating the target surface roughness. When the operation based on the machining program is started, the surface roughness acquisition unit 11 of the control device 1 starts analyzing the block “G01 Z20.0 Rz3.0” to thereby acquire the target surface roughness Rz that is 3.0.

FIG. 4 illustrates an example of a table of the tool surface roughness information. In the case of the example illustrated in FIG. 4, at least the tool numbers T01 to T06 and information regarding the nose R corresponding to each of the tool numbers T01 to T06 are stored in a table format in the second storage unit 20. The tool surface roughness information acquisition unit 12 acquires the tool surface roughness information, based on a tool number described in the machining program and a table as illustrated in FIG. 4. In this example, the tool number “T05” included in the machining program and the nose R 0.4 (mm) corresponding thereto are acquired as the tool surface roughness information.

It should be noted that the method of acquiring the tool surface roughness information is not particularly limited. For example, the tool surface roughness information acquisition unit 12 may acquire the tool surface roughness information by referring to a tool number and a table stored in the second storage unit 20, or may acquire, from the second storage unit 20, the tool surface roughness information specified in advance based on a tool number and the table.

The feed amount control unit 14 determines a feed rate based on the target surface roughness acquired by the surface roughness acquisition unit 11 and the tool surface roughness information acquired by the tool surface roughness information acquisition unit 12. In the case where a maximum depth Rz is defined as an indicator of the target surface roughness, the feed amount control unit 14 calculates the feed rate according to the following expression. In this example, when the target surface roughness h=3.0 and the nose R=0.4 are substituted into the following equation, it is given that the feed amount F≈0.098 (mm/rev).

$$h = \frac{{f}^{2}}{8 RE} \times 1000 ( μm ) \qquad [ Exp . 1 ]$$

In Expression (1), h represents the target surface roughness Rz (μm), f represents a feed amount (mm/rev) per rotation of the spindle, and RE represents a nose R (mm) indicating the shape of the cutting edge of the cutting tool T.

The feed amount control unit 14 controls the motor 3 at the feed amount that is based on the target surface roughness until the target surface roughness in the machining program is updated. When the target surface roughness in the machining program is updated, the motor 3 is controlled at a feed amount calculated based on the updated new target surface roughness.

The tool surface roughness information acquisition unit 12 monitors a state of the surface roughness of the cutting tool T. For this purpose, for example, the tool surface roughness information acquisition unit 12 monitors whether or not the cutting tool T has been replaced. When replacement of the cutting tool T is detected, the tool surface roughness information acquisition unit 12 recalculates the feed amount information based on the surface roughness information regarding the cutting tool T after replacement and the target surface roughness.

As another means for monitoring the state of the surface roughness of the cutting tool T, the shape of the bit of the cutting tool T is monitored. Upon detecting a change in the shape of the bit of the cutting tool T, the tool surface roughness information acquisition unit 12 recalculates the feed amount information based on tool shape information indicating the shape of the bit of the cutting tool T after the change and the target surface roughness.

The control device 1 according to the first embodiment for a machine tool that performs machining while relatively moving a cutting tool T and a workpiece W exerts the following effects.

The machine tool control device 1 according to the present embodiment includes: the surface roughness acquisition unit 11 that acquires a target surface roughness set for the workpiece W to be machined from a machining program; the tool surface roughness information acquisition unit 12 that acquires tool surface roughness information regarding a surface roughness of the cutting tool T; and the feed amount control unit 14 that determines, based on the tool surface roughness information, feed amount information regarding a feed amount per rotation of the cutting tool T and the workpiece W such that a surface roughness of the workpiece W becomes equal to the target surface roughness. Due to this feature, since the target surface roughness is set in the machining program, the feed amount can be controlled based on the target surface roughness, the readability of the machining program can be improved, and the time and effort for creating the machining program can be reduced. Furthermore, even if the cutting tool T is replaced or the shape of the cutting edge (e.g., nose R) of the cutting tool T is changed after a start of machining, the feed amount information can be recalculated based on the target surface roughness and surface roughness information regarding the cutting tool T, thereby making it possible to achieve a desired surface roughness with high accuracy.

In the present embodiment, upon detecting a change in the tool surface roughness information regarding the cutting tool T, the tool surface roughness information acquisition unit 12 acquires the tool surface roughness information after the change, and the feed amount control unit 14 redetermines the feed amount information in which the tool surface roughness information after the change is reflected. This feature makes it possible to quickly reflect, in the feed amount information, replacement of the cutting tool T and a change in the cutting edge of the cutting tool T due to wear.

In the present embodiment, the surface roughness acquisition unit 11 continuously outputs the target surface roughness previously acquired from the machining program to the feed amount control unit 14 until the surface roughness acquisition unit 11 acquires a next target surface roughness from the machining program. Due to this feature, the command of the target surface roughness serves as modal information, thereby making it easy to create the machining program.

### Second Embodiment

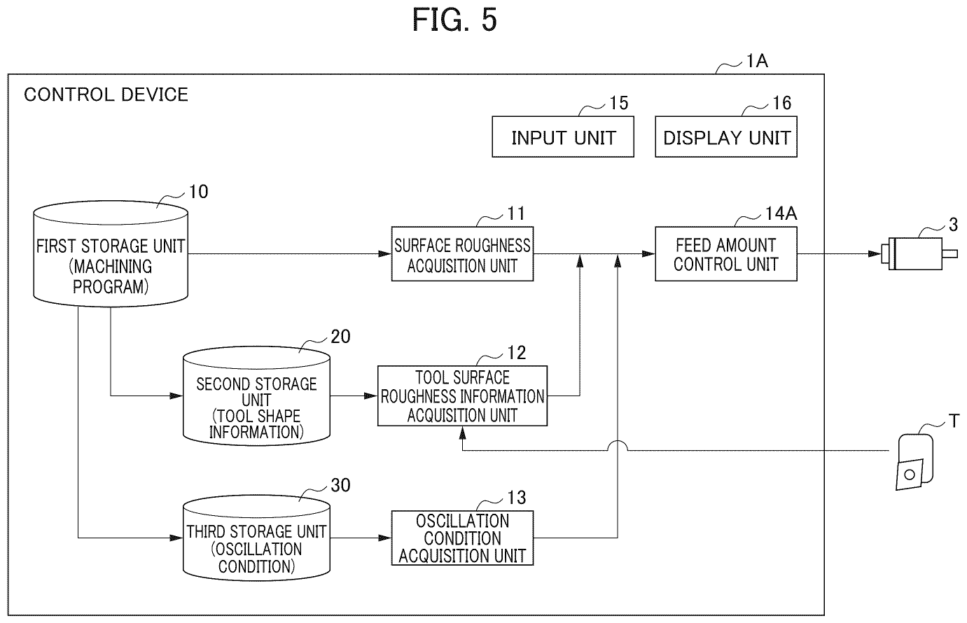

FIG. 5 is a functional block diagram of a machine tool control device 1A according to a second embodiment. The control device 1A according to the second embodiment controls a machine tool that performs oscillating cutting while relatively oscillating a cutting tool T and a workpiece. As illustrated in FIG. 5, the machine tool control device 1A according to the second embodiment is the same as the machine tool control device 1 according to the first embodiment, except that the machine tool control device 1A further includes a third storage unit 30 and a oscillation condition acquisition unit 13, and a feed amount control unit 14A performs control in a different manner.

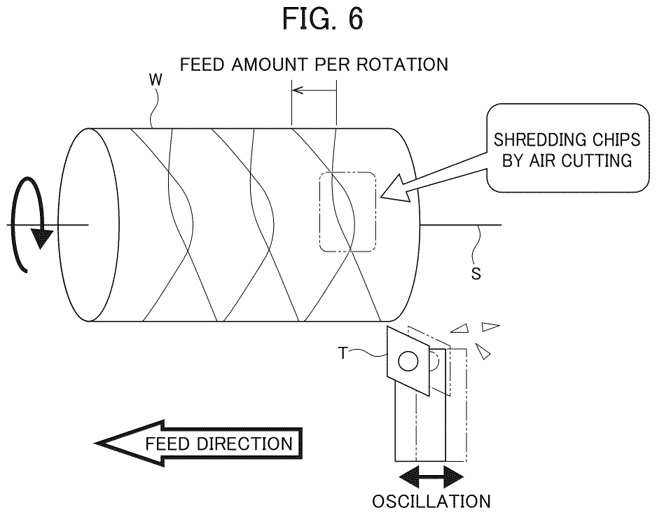

FIG. 6 is a diagram for explaining the oscillating cutting. In the example of the oscillating cutting illustrated in FIG. 6, at least one spindle S that relatively rotates the cutting tool T and the workpiece W and at least one feed shaft that moves the cutting tool T relative to the workpiece W are operated, so that cutting is performed while the cutting tool T and the workpiece W are relatively oscillated in a feed direction, concurrently with the relative rotation of the cutting tool T and the workpiece W. At this time, a setting is made on the tool path, which is the trajectory of the cutting tool T, such that the current path partially overlaps with the previous path. Specifically, since a portion machined in the previous path is partially included in the current path, the cutting edge of the cutting tool T is caused to perform idle motion while being separate from the surface of the workpiece W, which is called air cutting, whereby chips are shredded.

The third storage unit 30 stores therein an oscillation condition for performing the oscillating cutting. The oscillation condition is acquired from, for example, a machining program. The oscillation condition includes information regarding the number of oscillations per relative rotation of the cutting tool and the workpiece W, and information regarding an oscillation amplitude with respect to a feed amount per relative rotation of the cutting tool and the workpiece W. An example of the information regarding the number of oscillations per relative rotation of the cutting tool and the workpiece W is an oscillation frequency multiplying factor I (times) that indicates an oscillation frequency per rotation of the spindle. An example of the information regarding the oscillation amplitude with respect to the feed amount per relative rotation of the cutting tool and the workpiece W is an oscillation amplitude multiplying factor K (times) that indicates the magnitude of an oscillation amplitude with respect to the magnitude of a feed amount per rotation of the spindle. The oscillation frequency multiplying factor I (times) may be directly designated, or may be calculated from an oscillation frequency (Hz), which is designated beforehand, and a spindle rotation number S (1/min). Likewise, the oscillation amplitude multiplying factor K (times) may be directly designated, or may be calculated from an oscillation amplitude (mm), which is designated beforehand, a feed rate (mm/min), and a spindle rotation number S (1/min).

The oscillation condition acquisition unit 13 acquires the oscillation condition and outputs the oscillation condition to the feed amount control unit 14A. The oscillation condition acquisition unit 13 acquires the oscillation condition from the third storage unit 30. The oscillation condition acquisition unit 13 can acquire an oscillation condition designated by means of an external signal or the like. The oscillation condition acquisition unit 13 outputs the acquired oscillation condition to the feed amount control unit 14A.

The feed amount control unit 14A of the second embodiment calculates feed amount information based on a target surface roughness inputted from the surface roughness acquisition unit 11, tool surface roughness information inputted from the tool surface roughness information acquisition unit 12, and the oscillation condition inputted from the oscillation condition acquisition unit 13. The motor 3 is controlled based on the feed amount information calculated by the feed amount control unit 14A, whereby oscillating cutting is performed.

When the oscillation condition in the machining program is updated, the updated oscillation condition is stored in the third storage unit 30. The oscillation condition acquisition unit 13 monitors whether or not the oscillation condition has changed. The oscillation condition changes, for example, when the oscillation condition in the machining program is changed or an external signal causes a change in the oscillation condition. Upon detecting a change in the oscillation condition, the feed amount control unit 14A recalculates the feed amount information based on the oscillation condition after change, the tool surface roughness information, and the target surface roughness.

The machine tool control device 1A according to the second embodiment exerts following effects.

The machine tool control device 1A according to the present embodiment includes, in addition to the surface roughness acquisition unit 11 and the tool surface roughness information acquisition unit 12, the oscillation condition acquisition unit 13 that acquires an oscillation condition for oscillating cutting in which the cutting tool T and the workpiece W are relatively oscillated, and the feed amount control unit 14A determines the feed amount information based on the tool surface roughness information and the oscillation condition such that a surface roughness of the workpiece W becomes equal to the target surface roughness. Due to this feature, the following effect is achieved in addition to the effects of the control device 1 of the first embodiment. Even if the oscillation condition is changed after a start of machining, the feed amount information is recalculated based on not only the target surface roughness and the tool surface roughness information regarding the cutting edge of the cutting tool T, but also the oscillation condition after the change, thereby making it possible to achieve a desired surface roughness with accuracy also in the oscillation cutting. Furthermore, it is possible to reduce the time and effort for determining a feed rate in consideration of the oscillation condition.

Upon detecting a change in the oscillation condition, the oscillation condition acquisition unit 13 of the present embodiment acquires the oscillation condition after the change, and the feed amount control unit 14A redetermines the feed amount information in which the oscillation condition after the change is reflected. This feature makes it possible to quickly reflect a change that has occurred in the oscillation condition after a start of machining in the feed amount information.

### Third Embodiment

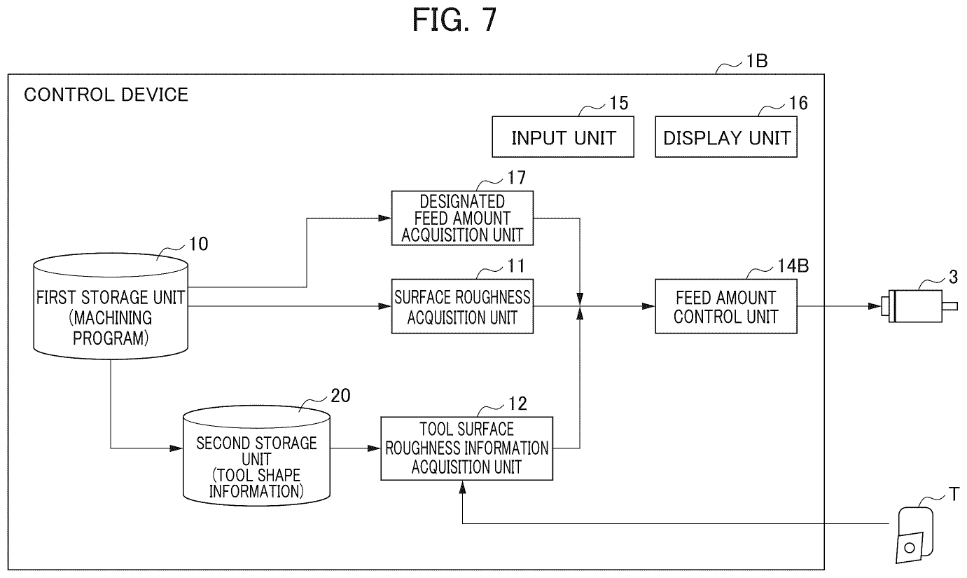

FIG. 7 is a functional block diagram of a machine tool control device 1B according to a third embodiment. The control device 1B according to the third embodiment controls a machine tool that performs cutting while relatively moving a cutting tool T and a workpiece. As illustrated in FIG. 7, the machine tool control device 1B according to the third embodiment is the same as the machine tool control device 1 according to the first embodiment, except that the machine tool control device 1B further includes a designated feed amount acquisition unit 17, and a feed amount control unit 14B performs control in a different manner.

The designated feed amount acquisition unit 17 acquires designated feed amount information that indicates designation of information regarding a feed amount per relative rotation of a cutting tool T and a workpiece W. The designated feed amount information is a numerical value that is set in advance and expressed in the same unit as that of the feed amount information. The designated feed amount information is described in a machining program or inputted from the input unit 15, and is then set.

For example, in a case where the designated feed amount information is described in the machining program in the first storage unit 10, the designated feed amount acquisition unit 17 acquires the designated feed amount. After acquiring the designated feed amount information, the designated feed amount acquisition unit 17 outputs the designated feed amount information to the feed amount control unit 14B.

In the case of acquiring the designated feed amount information from the designated feed amount acquisition unit 17, the feed amount control unit 14B according to the third embodiment gives priority to the designated feed amount information, and not to the feed amount information calculated based on a target surface roughness and tool surface roughness information. Accordingly, the motor 3 is controlled based on the designated feed amount information.

The machine tool control device 1B according to the third embodiment exerts the following effects.

Upon acquisition of the designated feed amount information that indicates designation of information regarding a feed amount per relative rotation of the cutting tool T and the workpiece W, the machine tool control device 1B according to the present embodiment controls a feed amount per relative rotation of the cutting tool T and the workpiece W based on the designated feed amount information. This feature makes it possible to flexibly address a case where it is better to designate a feed rate, such as a case in which there is a non-machining block.

The designated feed amount acquisition unit 17 of the third embodiment may be added to the configuration of the second embodiment, in which the oscillating cutting is performed. In this case, when acquiring the designated feed amount information, the feed amount control unit 14B controls the motor 3 with priority given to the designated feed amount information.

### Fourth Embodiment

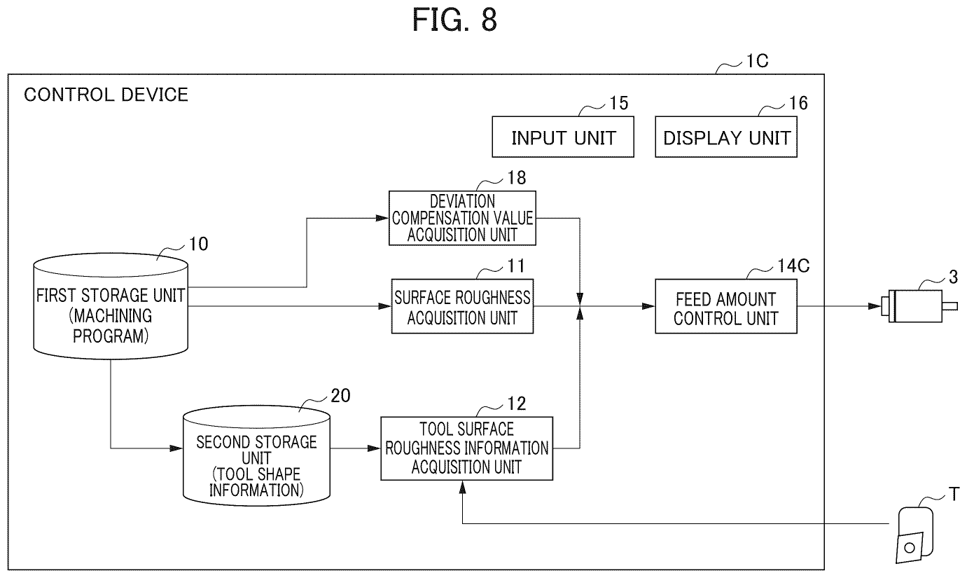

FIG. 8 is a functional block diagram of a machine tool control device 1C according to a fourth embodiment. As illustrated in FIG. 8, the machine tool control device 1C according to the fourth embodiment is the same as the machine tool control device 1 according to the first embodiment, except that the machine tool control device 1C further includes a deviation compensation value acquisition unit 18, and a feed amount control unit 14C performs control in a different manner.

The deviation compensation value acquisition unit 18 acquires a deviation compensation value for compensating a deviation between theoretical and measured values of the surface roughness. The deviation compensation value is calculated based on, for example, a machining condition acquired from the first storage unit 10. The machining condition is calculated based on, for example, a machining condition including at least one of the material of the cutting edge of a cutting tool, the shape of the cutting edge of the cutting tool, a material of a workpiece W, a cutting speed, a cutting depth, or a cutting angle. The deviation compensation value may be calculated based on a parameter of a machine as necessary. The deviation compensation value acquisition unit 18 outputs the acquired deviation compensation value to the feed amount control unit 14C.

The feed amount control unit 14C of the fourth embodiment calculates feed amount information based on a target surface roughness inputted from the surface roughness acquisition unit 11, tool surface roughness information inputted from the tool surface roughness information acquisition unit 12, and the deviation compensation value acquired from the deviation compensation value acquisition unit 18. The motor 3 is controlled based on the feed amount information calculated by the feed amount control unit 14C, whereby cutting is performed.

The deviation compensation value acquisition unit 18 may use machine learning such as supervised learning. For example, a configuration may be adopted in which a learning model is constructed using a large number of data sets each including a machining condition and feed amount information regarding a feed amount as an input and an actual surface roughness as an output, and a deviation compensation value is determined based on a surface roughness that is an output result of the learning model.

The machine tool control device 1C according to the fourth embodiment exerts the following effects.

The machine tool control device 1C according to the present embodiment further includes the deviation compensation value acquisition unit 18 that acquires a deviation compensation value for compensating a deviation between a theoretical value of the surface roughness and a measurement value of an actual surface roughness of the workpiece W, and the feed amount control unit 14C determines feed amount information in consideration of the deviation compensation value. Due to this feature, the feed amount information is determined in consideration of the deviation between the theoretical and actual values of the surface roughness, thereby making it possible to achieve a desired surface roughness by performing machining with higher accuracy.

The deviation compensation value acquisition unit 18 of the fourth embodiment may be added to the configuration of the second embodiment, in which the oscillating cutting is performed. In this case, the deviation compensation value acquisition unit 18 preferably determines the feed amount information in consideration of an oscillation condition in addition to the machining condition. In the case of combining machine learning, it is preferable to add the oscillation condition to the input of each data set.

### Fifth Embodiment

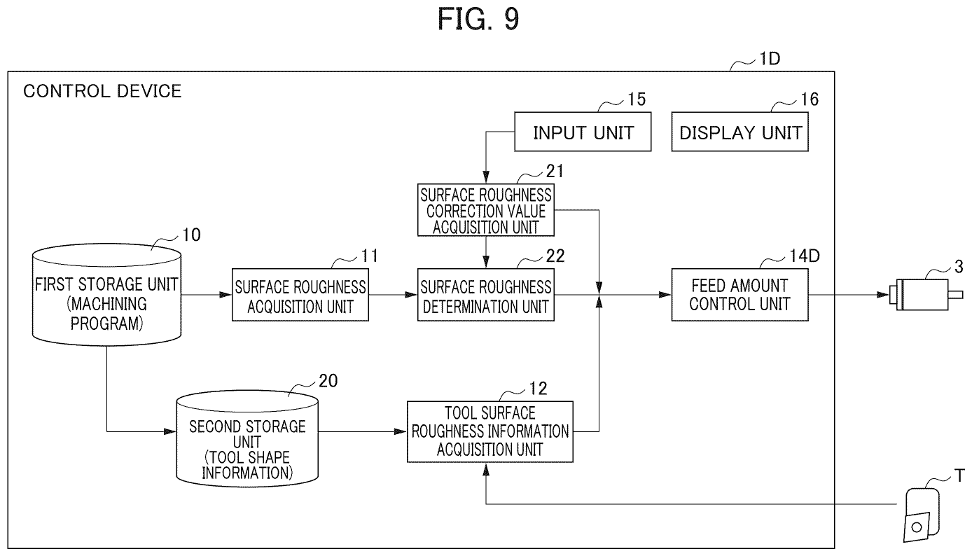

FIG. 9 is a functional block diagram of a machine tool control device 1D according to a fifth embodiment. As illustrated in FIG. 9, the machine tool control device 1D according to the fifth embodiment is the same as the machine tool control device 1 according to the first embodiment, except that the machine tool control device 1D further includes a surface roughness correction value acquisition unit 21 and a surface roughness determination unit 22, and a feed amount control unit 14D performs control in a different manner.

The surface roughness correction value acquisition unit 21 acquires a surface roughness correction value for correcting a target surface roughness. The surface roughness correction value acquisition unit 21 acquires, for example, a multiplying factor (correction coefficient) designated by an operator operating an input means such as a dial of the input unit 15 or operating an external computer. A target surface roughness is defined as a reference having a value of 100%, and the operator can adjust a surface roughness by changing the value of the target surface roughness to 90%, 110%, or the like.

The surface roughness determination unit 22 uses the surface roughness correction value inputted from the surface roughness correction value acquisition unit 21 to correct the target surface roughness inputted from the surface roughness acquisition unit 11, and outputs the corrected target surface roughness to the feed amount control unit 14D.

The feed amount control unit 14D of the fifth embodiment calculates the feed amount information based on the corrected target surface roughness inputted from the surface roughness determination unit 22 and the tool surface roughness information inputted from the tool surface roughness information acquisition unit 12. The motor 3 is controlled based on the feed amount information calculated by the feed amount control unit 14D, whereby cutting is performed.

The machine tool control device 1D according to the fifth embodiment exerts the following effects.

The machine tool control device 1D according to the present embodiment further includes: the surface roughness correction value acquisition unit 21 that acquires a surface roughness correction value for correcting the target surface roughness; and the surface roughness determination unit 22 that determines a surface roughness based on the target surface roughness acquired by the surface roughness acquisition unit 11 and the surface roughness correction value acquired by the surface roughness correction value acquisition unit 21, and the feed amount control unit 14D determines the feed amount information such that the surface roughness determined by the surface roughness determination unit 22 is achieved. This feature allows the operator to adjust the accuracy of the surface roughness of a machined surface without having to change the machining program.

The surface roughness correction value acquisition unit 21 and the surface roughness determination unit 22 of the fifth embodiment may be added to the configuration of the other embodiments such as the second embodiment, in which the oscillating cutting is performed.

### Sixth Embodiment

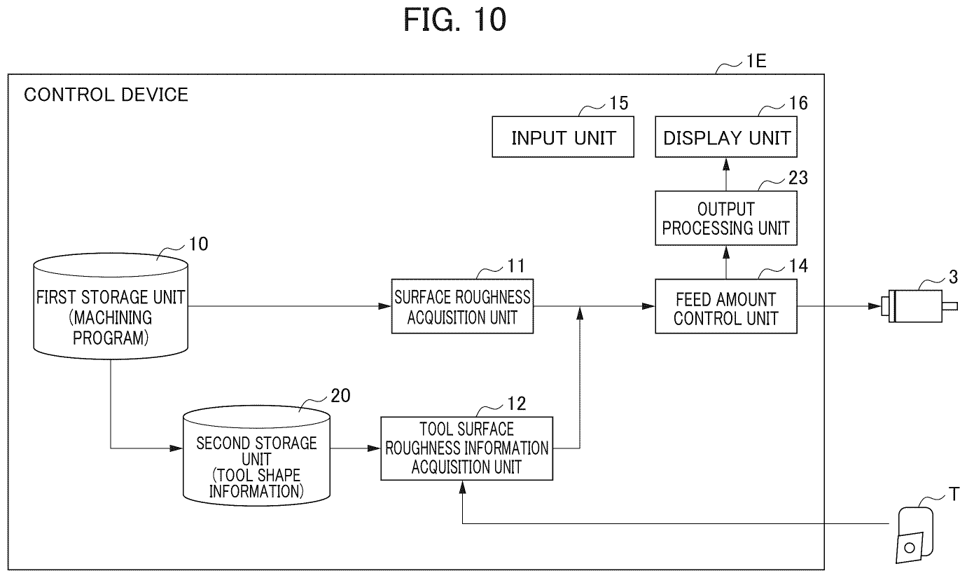

FIG. 10 is a functional block diagram of a machine tool control device 1E according to a sixth embodiment. As illustrated in FIG. 10, a machine tool control device 1E according to the sixth embodiment is the same as the machine tool control device 1 according to the first embodiment, except that the machine tool control device 1E further includes an output processing unit 23.

The output processing unit 23 executes display processing for outputting feed amount information determined by the feed amount control unit 14 to the display unit 16. The display unit 16 displays on a screen the feed amount information subjected to the display processing by the output processing unit 23 on a screen. For example, the display unit 16 displays a feed amount F (mm/rev) per rotation of a spindle, a spindle rotation number (rev/min), a feed amount (mm/min), and the like as the feed amount information on the screen.

The machine tool control device 1E according to the sixth embodiment exerts the following effects.

The control device 1E of the machine tool according to the present embodiment further includes the output processing unit 23 that outputs the feed amount information determined by the feed amount control unit 14 to the display unit 16. This feature allow the operator to check the feed amount information displayed on the display screen or the like by the display unit 16, whereby the operator can easily check the safety and a production plan.

The output processing unit 23 of the sixth embodiment may be added to the configuration of other embodiments such as the second embodiment, in which the oscillating cutting is performed.

It should be noted that the present disclosure is not limited to the above-described embodiments, and modifications and improvements within a range in which the object of the present disclosure can be achieved are encompassed in the present disclosure.

### EXPLANATION OF REFERENCE NUMERALS

1, 1A, 1B, 1C, 1D, 1E: Machine tool control device
11: Surface roughness acquisition unit
12: Tool surface roughness information acquisition unit
13: Oscillation condition acquisition unit
14, 14A, 14B, 14C, 14D: Feed amount control unit
16: Display unit
17: Designated feed amount acquisition unit
18: Deviation compensation value acquisition unit
21: Surface roughness correction value acquisition unit
22: Surface roughness determination unit
23: Output processing unit

1. A machine tool control device for a machine tool that performs machining while relatively moving a cutting tool and a workpiece, the machine tool control device comprising:
a surface roughness acquisition unit configured to acquire a target surface roughness set for the workpiece to be machined from a machining program;
a tool surface roughness information acquisition unit configured to acquire tool surface roughness information regarding a surface roughness of the cutting tool; and
a feed amount control unit configured to determine, based on the tool surface roughness information, feed amount information regarding a feed amount per relative rotation of the cutting tool and the workpiece such that a surface roughness of the workpiece becomes equal to the target surface roughness.

2. The machine tool control device according to claim 1, further comprising:
an oscillation condition acquisition unit configured to acquire an oscillation condition for oscillating cutting in which the cutting tool and the workpiece are relatively oscillated, wherein
the feed amount control unit determines the feed amount information based on the tool surface roughness information and the oscillation condition such that the surface roughness of the workpiece becomes equal to the target surface roughness.

3. The machine tool control device according to claim 2, wherein
upon detecting a change in the oscillation condition, the oscillation condition acquisition unit acquires the oscillation condition after the change, and
the feed amount control unit redetermines the feed amount information in which the oscillation condition after the change is reflected.

4. The machine tool control device according to claim 1, wherein
upon detecting a change in the tool surface roughness information regarding the cutting tool, the tool surface roughness information acquisition unit acquires the tool surface roughness information after the change, and
the feed amount control unit redetermines the feed amount information in which the tool surface roughness information after the change is reflected.

5. The machine tool control device according to claim 1, wherein
the surface roughness acquisition unit continuously outputs the target surface roughness previously acquired from the machining program to the feed amount control unit until the surface roughness acquisition unit acquires a next target surface roughness from the machining program.

6. The machine tool control device according to claim 1, wherein
upon acquiring designated feed amount information that indicates designation of information regarding a feed amount per relative rotation of the cutting tool and the workpiece, the feed amount control unit controls a feed amount per relative rotation of the cutting tool and the workpiece based on the designated feed amount information.

7. The machine tool control device according to claim 1, further comprising:
a deviation compensation value acquisition unit configured to acquire a deviation compensation value for compensating a deviation between a theoretical surface roughness value and an actual surface roughness value of the workpiece, wherein
the feed amount control unit determines the feed amount information in consideration of the deviation compensation value.

8. The machine tool control device according to claim 1, further comprising:
a surface roughness correction value acquisition unit configured to acquire a surface roughness correction value for correcting the target surface roughness; and
a surface roughness determination unit configured to determine a surface roughness based on the target surface roughness acquired by the surface roughness acquisition unit and the surface roughness correction value acquired by the surface roughness correction value acquisition unit, wherein
the feed amount control unit determines the feed amount information such that the surface roughness determined by the surface roughness determination unit is achieved.

9. The machine tool control device according to claim 1, further comprising:
an output processing unit configured to output the feed amount information determined by the feed amount control unit to a display unit.
